(19) United States
(12) Patent Application Publication
(10) Pub. No.: US 2015/0037593 A1
(43) Pub. Date: Feb. 5, 2015

(54) LAMINATED PRODUCT, AN APPARATUS AND A METHOD FOR FORMING A LAMINATED PRODUCT

(71) Applicants: 3M Innovative Properties Company, Saint Paul, MN (US); Trimech Technology Pte. Ltd., Singapore (SG)

(72) Inventors: Wee Hock Chan, Singapore (SG); Xinhe Chen, Singapore (SG); Jia Tow, Singapore (SG); Chin Teong Ong, Singapore (SG); Yi Lin Sim, Singapore (SG)

(73) Assignees: 3M Innovative Properties Company, Saint Paul, MN (US); Trimech Technology PTE. LTD., Singapore (CN)

(21) Appl. No.: 14/359,898

(22) PCT Filed: Nov. 22, 2012
(86) PCT No.: PCT/SG2012/000438

§ 371 Date: May 21, 2014

(30) Foreign Application Priority Data
Nov. 22, 2011 (SG) 201108644-4

(51) Int. Cl. B32B 37/10; G02F 1/1339; B32B 7/12; B32B 37/12

(52) U.S. Cl. CPC B32B 37/10; B32B 37/1018; B32B 37/1292; G02F 1/1339; B32B 7/12; G02F 2202/28
USPC 428/426; 156/285; 156/580; 118/505

(57) ABSTRACT

There is a method for forming a laminated product having a first substrate and a second substrate. The method may comprise applying a liquid adhesive on a surface of the first substrate for bonding the first substrate to the second substrate. The liquid adhesive located on a circumferential periphery of the first substrate for limiting movement of the liquid adhesive within the circumferential adhesive wall structure. Pressure may be applied on a bond area between the first substrate and the second substrate in a vacuum environment to incrementally increase the bond area between the first substrate and the second substrate to incrementally bond the first substrate to the second substrate. The liquid adhesive may be cured to bond the first and second substrates.

### FIELD OF THE INVENTION

The present invention relates to processes for forming a laminated product. More particularly, the present invention relates to an apparatus and a method for forming a laminated product.

### BACKGROUND

The demand for reduction in the size of portable electronics products has driven innovations in interconnecting material used in electronics assemblies and processes for manufacturing electronics assemblies.

Adhesives are used as an interconnecting material for bonding various substrates such as polycarbonate, glass, and flexible film substrates to form laminated products including a display panel assembly, or a layered product.

Conventional lamination processes have encountered problems such as presence of air voids in the laminated product. When the laminated product is used in a display device having a viewing area, it is undesirable and generally not acceptable for air voids to be present within the viewing area.

Further, control of the adhesive flow is an important consideration in the lamination process. For example, “under flow” may occur when the adhesive stops flowing at an edge before the intended area of coverage on the first substrate is being covered. Alternatively, “overflow” may occur when the adhesive flow out of the intended area of coverage which upon curing can cause mechanical fitting problems in assemblies in which the laminated product is used. Still further, overflow of adhesive may cause problems in the manufacturing process of an electronic assembly such as a display assembly. For example, the overflow of the adhesive may contaminate adjacent components in the display assembly, and cause difficulty in transportation in the manufacturing process. As a result, additional cleaning steps may be required prior to curing and having such additional cleaning steps will increase the cycle time of the manufacturing process.

Currently, there are manufacturing methods that use a dam around the area of coverage of the substrate to form a dam area for receiving liquid adhesive overflowing from the area of coverage on the substrate. The dam is broken at corners of the dam to create an outgassing outlet at each corner of the dam to allow outgassing of gases in the adhesive. Liquid adhesive is dispensed into the dam area on the first substrate and a second substrate is press bonded to the first substrate. Gases such as air trapped in the laminated substrate may be released through the outgassing outlets.

However, such manufacturing methods require critical control of the timing of the adhesive flow which is difficult to control because the rate of flow of the adhesive may vary according to the viscosity of the liquid adhesives. Still further, any air void trapped will remain trapped in the laminated product.

The abovementioned problems in conventional lamination processes have resulted in low product yield in production which increases manufacturing costs since the defective substrate assemblies cannot be used and have to be disposed. Further, a laminated product whereby the adhesive is cured cannot be reworked.

### SUMMARY

There exists a need to address the abovementioned problems to obtain better yield in processes for forming laminated products.

In accordance with an aspect of the present invention, there is a method for forming a laminated product having a first substrate and a second substrate. The method may comprise applying a liquid adhesive on a surface of the first substrate for bonding the first substrate to the second substrate. The liquid adhesive located on a circumferential periphery of the first substrate may be cured so as to form a circumferential adhesive wall structure for limiting movement of the liquid adhesive within the circumferential adhesive wall structure. Pressure may be applied on a bond area between the first substrate and the second substrate in a vacuum environment for incrementally increasing the bond area between the first substrate and the second substrate to incrementally bond the first substrate to the second substrate. The liquid adhesive may be cured to bond the first and second substrates to form the laminated product.

Prior to the step of curing the liquid adhesive to form the circumferential adhesive wall structure, uneven application of liquid adhesive on the first substrate may be wiped to maintain uniform thickness of the liquid adhesive on the first substrate.

The liquid adhesive may be applied on the surface of the first substrate via a stencil with a cut out aperture corresponding to a shape of the intended lamination area on the surface of the first substrate. The stencil may be made of stainless steel.

Applying the pressure on the bond area, may include tilting the first substrate to lie in a plane inclined relative to the second substrate prior to incrementally increasing the bond area between the second substrate and the first substrate.

Tilting the first substrate may include:
providing the first substrate on a biasing support configured for holding the first substrate; and
biasing the support between a first position wherein the support is in alignment with the inclined plane and a second position wherein the support is biased to apply pressure on the bond area through the first substrate during the incremental increase of the bond area between the first substrate and the second substrate.

A first end of the support may be arranged to pivot about a base and the biasing mechanism is disposed between the base and the support.

The biasing mechanism may include a biasing member such as for example, a spring element or a rubber pad or an actuator. The actuator may be a spring based piston assembly.

The biasing mechanism may include two biasing members disposed between the support and a base whereby each of the two biasing members is disposed at one of two opposing ends of the support.

Curing the liquid adhesive located on the circumferential periphery of the first substrate may include partially curing liquid adhesive on the circumferential periphery of an adhesive print area. By partial curing, it is meant to include curing the liquid adhesive to an extent or degree such that the liquid adhesive on the first substrate may have a higher resistance to flow during lamination where pressure is applied on the first substrate such that the first and second substrates are compressed.

Curing the liquid adhesive may include providing a mask on the first substrate, the mask having an aperture for exposing the liquid adhesive on the circumferential periphery to a curing source. The liquid adhesive may be partially cured by using the curing source on the circumferential periphery of the first substrate to form the circumferential adhesive wall structure. The curing source may be a Ultra Violet (UV) curing source.

Curing the liquid adhesive may include partial curing the liquid adhesive on the circumferential periphery to form the circumferential adhesive wall structure using a spot Light Emitting Diode (LED) UV light source.

The step of applying a liquid adhesive on a surface of the first substrate for bonding the first substrate to the second substrate may include:
providing a stencil on the surface of the first substrate, the stencil having a stencil portion with an aperture of size corresponding to the surface of the first substrate for receiving the liquid adhesive; and
stencil printing the liquid adhesive on the surface of the first substrate.

The stencil portion may include a tapered portion to minimize liquid adhesive from being scooped back to the adhesive print area on the surface. The scooping back of the liquid adhesive may form a hump at the edge of the adhesive print area which may cause air to be trapped in the laminated product.

The stencil portion may include a recess adapted to accommodate excess flow of liquid adhesive from the aperture.

The recess may have a depth of less than the thickness of the stencil portion and an area extending along an edge of the stencil portion adjacent to the aperture.

The first and the second substrates may be made of a rigid material. Alternatively, the first substrate or the second substrate may be made of a flexible material.

The first substrate may be a LCD module having a viewing area, and the second substrate may be a glass substrate having a bottom surface for bonding with the viewing area. The bottom surface of the glass substrate may include a coloured masking extending from an outer circumferential periphery of the glass substrate to an outer circumferential periphery of the viewing area.

Curing the liquid adhesive may include curing the liquid adhesive on a circumferential periphery of the LCD substrate and under the coloured masking of the glass substrate. The curing may include UV curing.

According to an aspect of the present invention, there is an apparatus for forming a laminated product having a first substrate and a second substrate, the lamination system comprising:
a stencil printing device for applying a liquid adhesive on a surface of the first substrate for bonding the first substrate to the second substrate;
a bonding device having:
   a platen configured for holding a second substrate and for applying pressure on a bond area between the first substrate and the second substrate;
   a support configured for holding a first substrate; and
   a biasing mechanism configured to bias the support between a first position wherein the support lies in a plane inclined relative to the second substrate, and a second position wherein the support is biased to apply pressure on the bond area through the first substrate to incrementally increase the bond area on which the pressure is applied to incrementally bond the first substrate to the second substrate;
   a curing device for curing the liquid adhesive, wherein the liquid adhesive located on a circumferential periphery of the first substrate is cured by the curing device in a manner such that a circumferential adhesive wall structure is formed for limiting movement of the liquid adhesive within the circumferential adhesive wall structure before pressure is applied on the bond area by the actuator.

The curing device may be used with a mask to form the circumferential adhesive wall structure.

According to an aspect of the present invention, there is a stencil for printing adhesive in a process for forming a laminated product for a display device having a first substrate and a second substrate. The stencil may comprise a stencil portion with an aperture. The aperture may be of a size corresponding to a surface of the first substrate for receiving a liquid adhesive on the surface of the first substrate.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1A is a top view of a substrate having a layer of adhesive printed on the substrate with a first stencil;

FIG. 1B is a cross-sectional view of a substrate having a layer of adhesive printed on the substrate with the first stencil of FIG. 1A;

FIG. 1C is a cross-sectional view of a substrate having a layer of adhesive printed on the substrate with the first stencil of FIG. 1A;

FIG. 2A is a top view of a substrate having a layer of adhesive printed on the substrate with a second stencil;

FIG. 2B is a cross-sectional view of the second stencil of FIG. 2A;

FIG. 3 is a top view of an example of a cover glass for a display device having a microphone outlet;

FIG. 4 is a top view of a substrate having a layer of adhesive printed on the substrate;

FIG. 5A is a front view of an apparatus for forming a laminated product prior to lamination;

FIG. 5B is a front view of an apparatus for forming a laminated product during lamination;

FIG. 6 is a front view of a biasing support;

FIG. 7 is a front view of a biasing support;

FIG. 8A is a front view of a biasing support prior to tilting;

FIG. 8B is a front view of the biasing support of FIG. 8B in a tilted position;

FIG. 9 is a cross-sectional view of a laminated product during a full curing step;

FIG. 10A is a cross-sectional view of a substrate assembly during an edge curing step;

FIG. 10B is a cross-sectional view of a laminated product during a full curing step;

FIG. 11 is a flow chart of a method for forming a laminated product;

FIG. 12 is a flow chart of a method for curing the liquid adhesive to form the laminated product;

FIG. 13 is a side view of a stencil printing device during a liquid adhesive printing step using a stencil with a recess;

FIG. 14A is a top view of a stencil printing device during a liquid adhesive printing step using a stencil with a first recess and a second recess;

FIG. 14B is a side view of the stencil printing device of FIG. 14A during a liquid adhesive printing step;

FIG. 14C is a side view of the stencil printing device of FIG. 14A at the end of the liquid adhesive printing step;

FIG. 15A is a side view of a stencil printing device at the beginning of a liquid adhesive printing step;

FIG. 15B is a top view of the stencil printing device of FIG. 15A during the liquid adhesive printing step;

FIG. 15C is a side view of the stencil printing device of FIG. 15A during the liquid adhesive printing step;

FIG. 15D is a side view of the stencil printing device of FIG. 15A at the end of the liquid adhesive printing step;

FIG. 16 is a front view of a wiper with a substrate with liquid adhesive printed on the first substrate;

FIG. 17 is a front view of the wiper of FIG. 16; and

FIGS. 18A, 18B and 18C illustrate examples of wipers with different cross sectional areas.

These figures are not drawn to scale and are intended merely for illustrative purposes.

### DETAILED DESCRIPTION

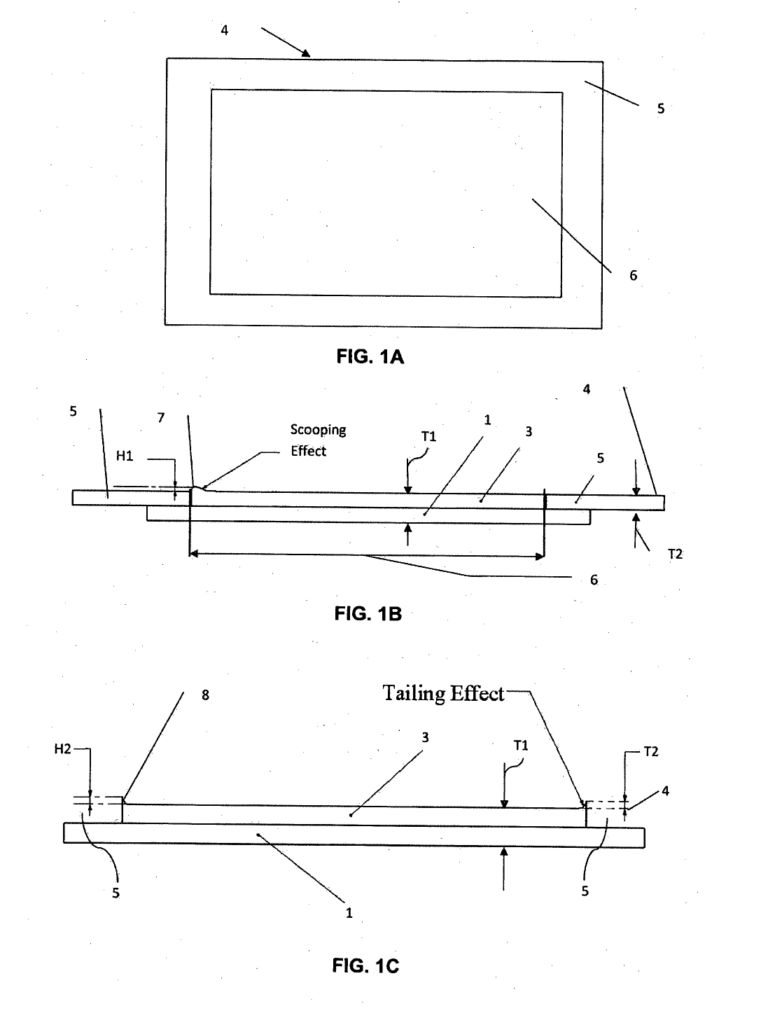

A process for forming a laminated product having a first substrate and a second substrate begins with applying liquid adhesive on the first substrate. Applying of the liquid adhesive on the first substrate may be done by stencil printing the liquid adhesive on an intended print area of the surface of the first substrate. In particular, liquid adhesive may be a printable adhesive which may be stencil printed on the first substrate using a stencil 4 as shown in FIG. 1A.

FIG. 1A shows a top view of the stencil 4 for printing adhesive in the process for forming a laminated product. The stencil 4 has a stencil portion 5 with an aperture 6 of size corresponding to a surface of a first substrate 1 for receiving a liquid adhesive or a printing area on the first substrate 1. FIG. 1A illustrates shows the first substrate 1 with a liquid adhesive layer 3 printed on the first substrate 1. The liquid adhesive 3 may be applied on a surface of the first substrate 1 by a stencil printer capable of printing adhesives. The stencil 4 is used for the stencil printing of the liquid adhesive layer 3 on the first substrate 1.

Referring to FIG. 1A, the stencil 4 has a stencil portion 5 with an aperture 6 of a size corresponding to a printing area on the surface of the first substrate 1 for receiving a liquid adhesive 3. The printing area may be defined by the intended lamination area between the first substrate 1 and the second substrate (not shown) and may be dependent on the volume of liquid adhesive required in forming a laminated product. For example, the thickness distribution of the liquid adhesive layer 3 printed on the first substrate 1 may be within 5% of an adhesive thickness profile defined by the requirements of an end product in which the laminated product is used.

Due to the rheological properties of liquid adhesives, the liquid adhesive 3 may not be released completely from the aperture 6 of the stencil 4. Referring to FIG. 1B, to obtain a required thickness T1 of a liquid adhesive layer 3 deposited on the first substrate 1, the stencil portion 5 may have a thickness T2 equivalent to or greater than the thickness T1. Still further, it has been observed in the process of printing the liquid adhesive 3 that there may be “scooping” of adhesive 3 whereby the liquid adhesive layer 3 has a hump profile 7 as shown in FIG. 1B. Alternatively, there may be “tailing” of the liquid adhesive 3 whereby the liquid adhesive layer 3 has a tail profile 8 as shown in FIG. 1C. Adhesive evenness or planarity is an important factor in the process for forming a laminated product. Hence such “scooping” and “tailing” effects are not desired in the lamination process because it may result in an uneven layer of the liquid adhesive which, upon lamination, may result in voids in the laminated product.

Process controls may be introduced in the printing process to ensure that a height H1 of the hump profile 7 of the scooping or a height H2 of the tail profile 8 does not exceed the thickness T1. Alternatively, during substrate and stencil separation, a stencil design may be modified to address the scooping and tailing effects.

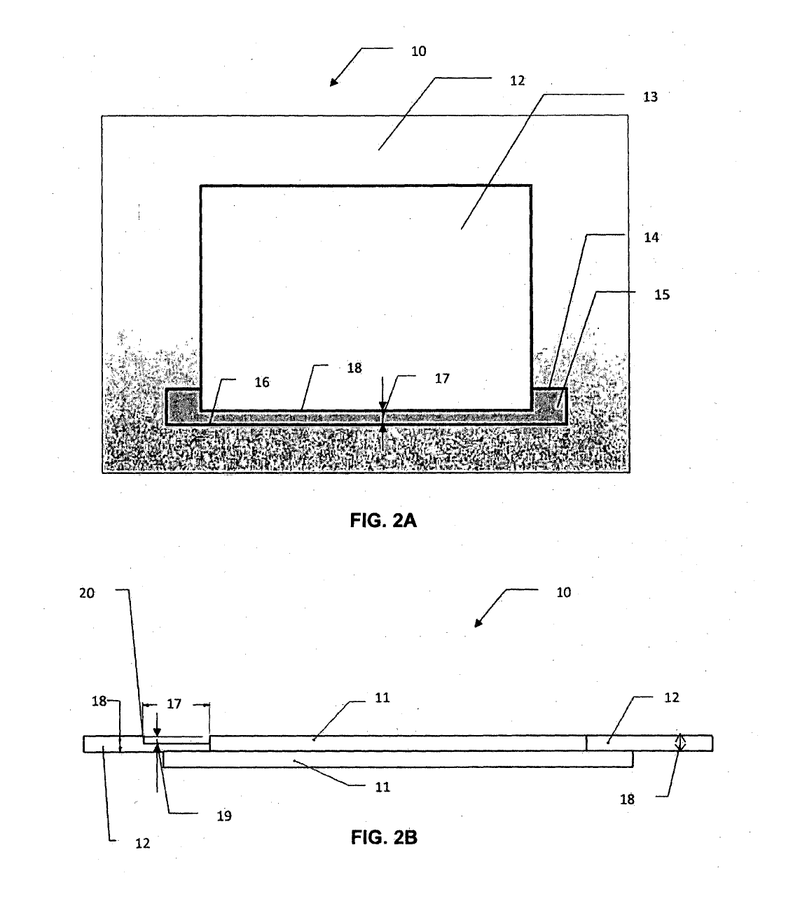

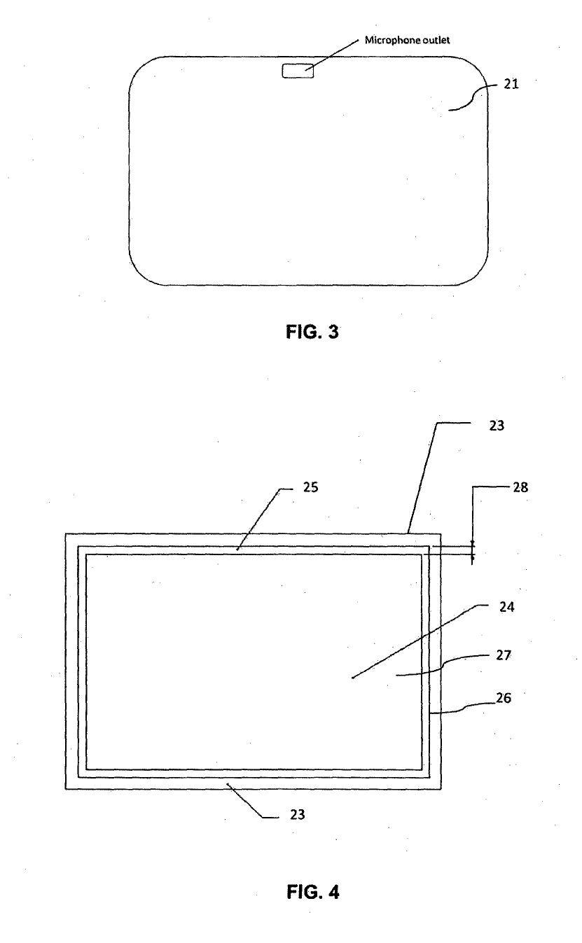

FIG. 2A shows a top view of a stencil 10 for printing adhesive in a process for forming a laminated product having a first substrate 11 and a second substrate (not shown). The stencil 10 has a stencil portion 12 with an aperture 13 of size corresponding to a part of the surface of the first substrate 11. For example, the aperture 13 may be of size corresponding to an intended print area on the surface of the first substrate 10. The stencil 10 further includes a recess 14 adapted to allow excess flow of liquid adhesive from the aperture 13. The recess 14 may be defined by an area 15 extending along an edge 16 of the stencil portion 12 adjacent to the aperture 13. The area 15 may be defined by a distance 17 between the edge 16 and an edge 18 of the aperture 13. Referring to FIG. 2B, the recess 14 may have a depth 19 less than a thickness 20 of the stencil 10.

Printing of the adhesive on the first substrate 11 may be done by screen printing liquid adhesive through the aperture 14 to the surface of the first substrate, using printing methods such as stencil printing or depositing/dispensing adhesive through the aperture 14. FIG. 2B shows the first substrate 11 with a liquid adhesive layer 11 printed on the surface of the first substrate 11 using the stencil 10. The first substrate 11 may be for example, a LCD. The liquid adhesive layer 22 may include liquid optically clear adhesive (LOCA). During the printing of adhesive, a print head of the stencil printer (not shown) normally “sits” on or is supported by the stencil 10. Therefore an advantage of the stencil 10 is that the print head would sit in the recess 14 which is thinner than the thickness of the stencil 10, subsequently minimizing or eliminating the scooping effect at the end of the printing step. In this way, excess liquid adhesive material may be adhered to a surface of the stencil 10 while the print head is lifted from the first substrate 11 thereby leaving the liquid adhesive 22 in the intended print area on the first substrate 11.

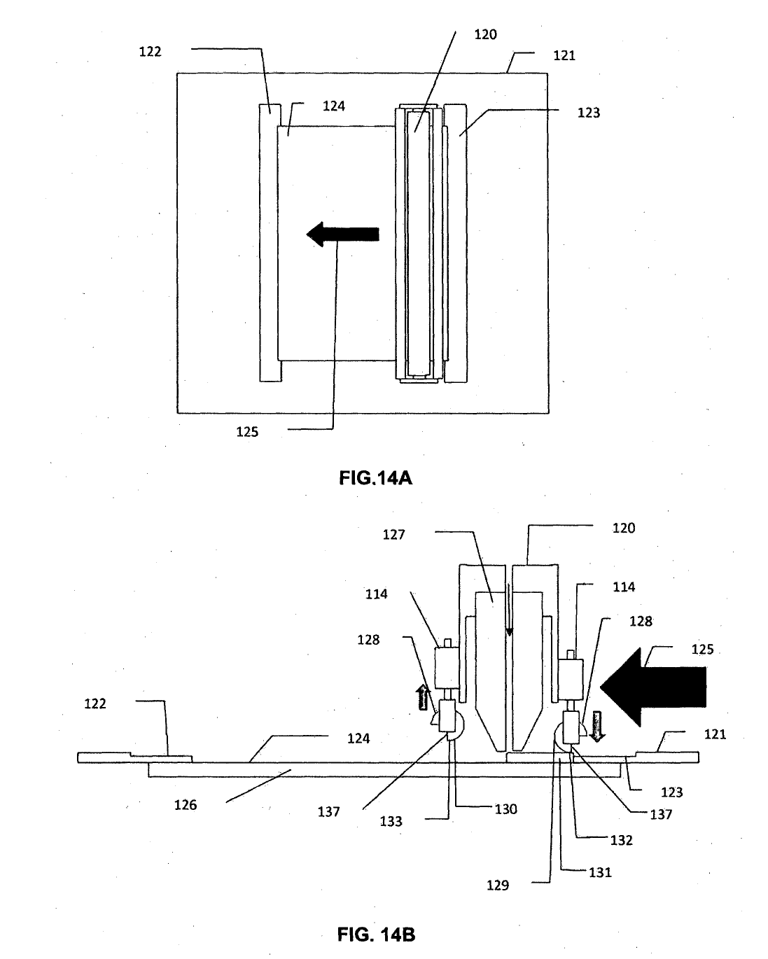

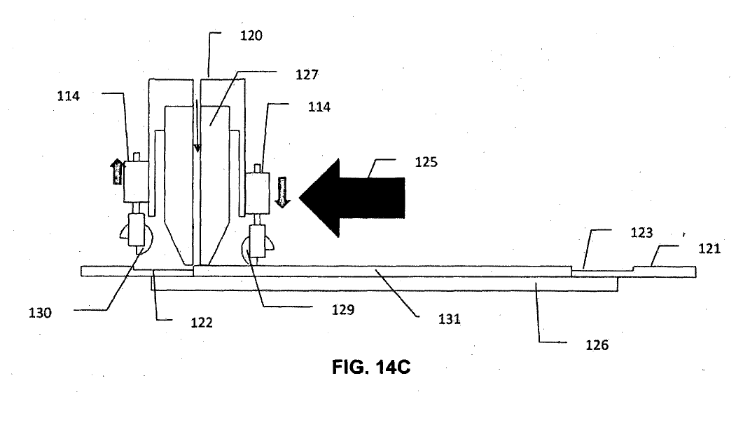

A second recess (shown in FIG. 14A as reference number 123) for accommodating excess flow of adhesive may be included in the stencil 10. The second recess may have a depth less than a thickness 20 of the stencil portion 12 and an area extending along a second edge of the stencil portion 12 opposite the edge 16 of the stencil portion 12. Alternatively, depending on a thickness of the stencil 10, the stencil portion 12 may include a tapered portion (not shown) to accommodate excess flow of adhesive. The stencil 10 may further include a second aperture in the stencil portion 12 to allow selective printing in situations such as for accommodating placement of a component of a display device. For example, referring to FIG. 2, the first substrate 11 may be a cover glass 21 for a mobile phone or a display device and the second aperture may be of a size corresponding to an opening in the cover glass 21 for a microphone outlet in a touch screen phone device.

The stencil 4, 10 may be made of a material suitable for printing adhesives such as for example, stainless steel. The thickness of the stencil 4, 10 may vary according to the required thickness of the adhesive.

In an embodiment, the liquid adhesive printed on the first substrate may be partially cured prior to applying pressure to bond a second substrate to a first substrate having liquid adhesive printed thereon. FIG. 4 shows a top view of a first substrate 23 with a liquid adhesive layer 24 printed thereon. Prior to applying pressure to bond a second substrate to the first substrate 23, the liquid adhesive 24 located on a circumferential periphery of the first substrate 23 may be cured so as to form a circumferential adhesive wall structure 25 as shown in FIG. 4. It will be appreciated that curing the liquid adhesive 24 located on a circumferential periphery of the first substrate 23 may include a full cure or a partial cure for curing or hardening liquid adhesive around the circumferential periphery 26 of the print area 27 to form the circumferential adhesive wall structure 25 while liquid adhesive 24 within the circumferential wall structure 25 remains uncured in a liquid state. The circumferential adhesive wall structure 25 may be formed by partially curing the liquid adhesive on a circumferential periphery 26 of a print area 27 (“circumferential cure”). Dependent on a size of the printing area, the circumferential adhesive wall structure 25 may have a circumferential width 28 in the range of 1 to 4 millimeters. The partial curing may be at 10 to 20% of a full curing step or a full curing cycle of a liquid adhesive such that only liquid adhesive around the circumferential periphery 26 of the print area 27 is hardened while liquid adhesive 24 within the circumferential wall structure 25 remains uncured in a liquid state. It will be appreciated that partial curing prior to applying pressure is to harden the liquid adhesive 24 around the circumferential periphery 26 of the print area 27 to a point where movement of the liquid adhesive will be restricted so as to minimize adhesive flow out of the outer periphery of the first substrate 23. In other words, the circumferential adhesive wall structure 25 formed as a result of the partial curing of the liquid adhesive 24 acts like a barrier to the flow of the uncured liquid adhesive on the first substrate 23. The circumferential adhesive wall structure 25 also acts like a guide for flow of the liquid adhesive under pressure applied during the bonding of a second substrate to the first substrate 23. Still further, excess flow out of the liquid adhesive is also minimized by the circumferential adhesive wall structure 25.

It will be appreciated that there are several methods for performing the circumferential cure. For example, a mask having an aperture for exposing the liquid adhesive to a curing source may be used for performing the circumferential cure. If the curing source is an Ultra violet (UV) light source, the mask may have a UV obstructing stencil portion adapted for blocking UV light directed to a center portion of the liquid adhesive printed onto the first substrate 23. The mask may also have an aperture for exposing the liquid adhesive on a circumferential periphery of an adhesive printed area of the first substrate 23 to the UV light source. The UV light source may include a plurality of UV Light Emitting Diodes (LEDs) arranged in a line array, or a UV lamp such as for example, a Xenon lamp.

Alternatively, the liquid adhesive on the circumferential periphery of the print area may be partially cured to form the circumferential adhesive wall structure by using a spot UV LED light source.

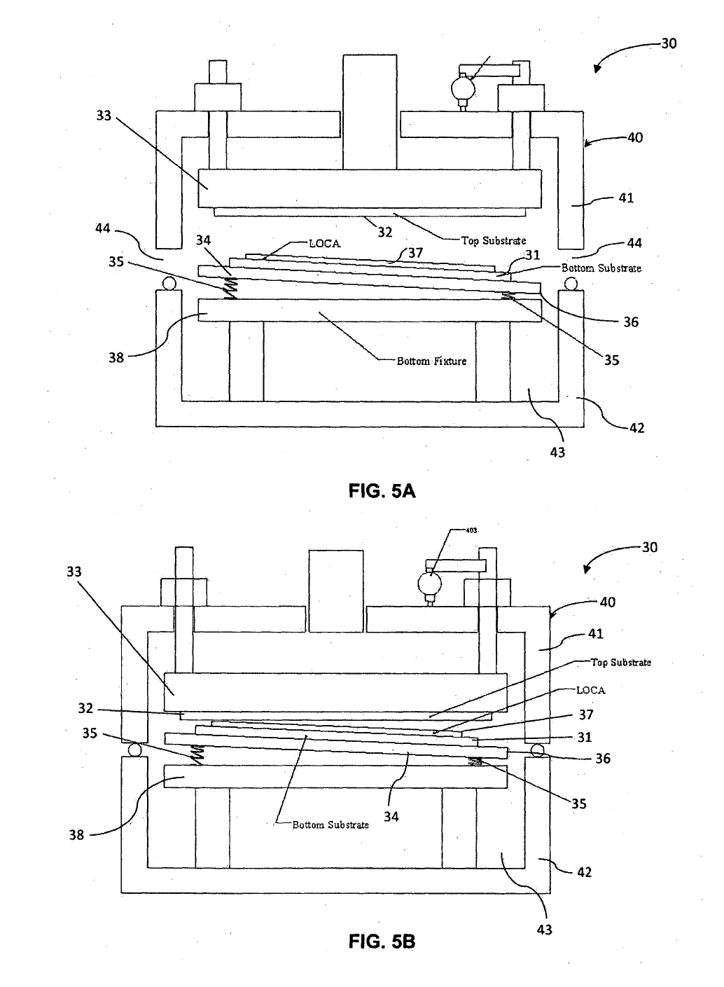

In an embodiment, there is an apparatus (not shown) for forming a laminated product having a first substrate and a second substrate. The apparatus includes a stencil printing device for applying a liquid adhesive on a surface of the first substrate for bonding the first substrate to the second substrate, a bonding device for bonding the first substrate to the second substrate, and a curing device for curing the liquid adhesive. The liquid adhesive located on a circumferential periphery of the first substrate may be cured by the curing device in a manner such that a circumferential adhesive wall structure is formed for limiting movement of the liquid adhesive within the circumferential adhesive wall structure before pressure is applied on the bond area by the actuator. The curing device may be used with a mask having an aperture for exposing the liquid adhesive to a curing source to form the circumferential adhesive wall structure. Further details of the bonding device is illustrated in FIG. 5A and FIG. 5B.

FIG. 5A is a front view of a bonding device 30 for forming a laminated product for a display device comprising a first substrate 31 and a second substrate 32. During the lamination process, the bonding device 30 may be located in a vacuum environment such as for example, a vacuum chamber 40 as shown in FIG. 5A.

The vacuum chamber 40 has an upper part 41 and a lower part 42 in sealed connection with the upper part 41 to define a vacuum environment 43. The upper part 41 may be movable relative to the lower part 42 to provide an outlet 44 to allow air to enter the vacuum environment 43 when it is desired to return a pressure setting to the vacuum chamber 40 to atmospheric pressure quickly. The vacuum pressure determines the pressure of the air void trapped during lamination. The vacuum pressure in the vacuum chamber 40 may be set close to perfect vacuum or a pressure up to 5000 pascal. Most preferably, for high yield production, the vacuum chamber 40 may be set at a vacuum chamber pressure below 5000 pascal. A lower vacuum chamber pressure will result in a lower pressure in the vacuum voids present in the substrate assembly if there is air trapped in the liquid adhesive. Such air voids may disappear after the substrate assembly is brought from a predetermined vacuum pressure to atmospheric pressure whereby the pressure difference will compress the voids to a size not visible to the naked eye.

The bonding device 30 has a platen 33 configured for holding a second substrate 32. The platen 33 is also configured for applying pressure on a bond area between the first substrate 31 with liquid adhesive 37 printed thereon and the second substrate 32. For example, the platen 33 may be part of a press machine coupled within the vacuum chamber 40.

The bonding device 30 also includes a support 34 configured for holding a first substrate 31 and a biasing mechanism 35 configured to bias the support 34 between a first position wherein the support 34 lies in a plane inclined relative to the second substrate 32 and a second position wherein the support 34 is biased to apply pressure on the bond area through the first substrate 31 to incrementally increase the bond area on which the pressure is applied to incrementally bond the first substrate 31 to the second substrate. The support 34 may be for example a plate or a planar support adapted or configured for holding the first substrate 31.

FIG. 5B is a front view of the bonding device 30 for forming a laminated product in operation whereby the platen 33 is lowered to apply pressure to press bond the second substrate 32 to the first substrate 31. By having the first substrate 31 in the inclined plane relative to the second substrate 32, the liquid adhesive 37 on the first substrate 31 will come into contact with the second substrate 32 incrementally by incrementally increasing the bond area between the first and second substrates 31, 32. A heater, such as an infrared heater may be used to apply heat on the liquid adhesive so as to temporarily decrease the viscosity of the liquid adhesive to help with air releasing and degassing from the substrates. Therefore, the first substrate 31 may be incrementally bonded to the second substrate 32. Incremental bonding or sealing of the substrates 31, 32 enables air to be pushed out of the first and second substrates 31, 32. The first substrate 31 may lie in the plane inclined at an angle of 0.1 to 2 degrees relative to the second substrate 32. Alternatively, the height of the inclined plane may be 0.2 to 5 millimeters (mm).

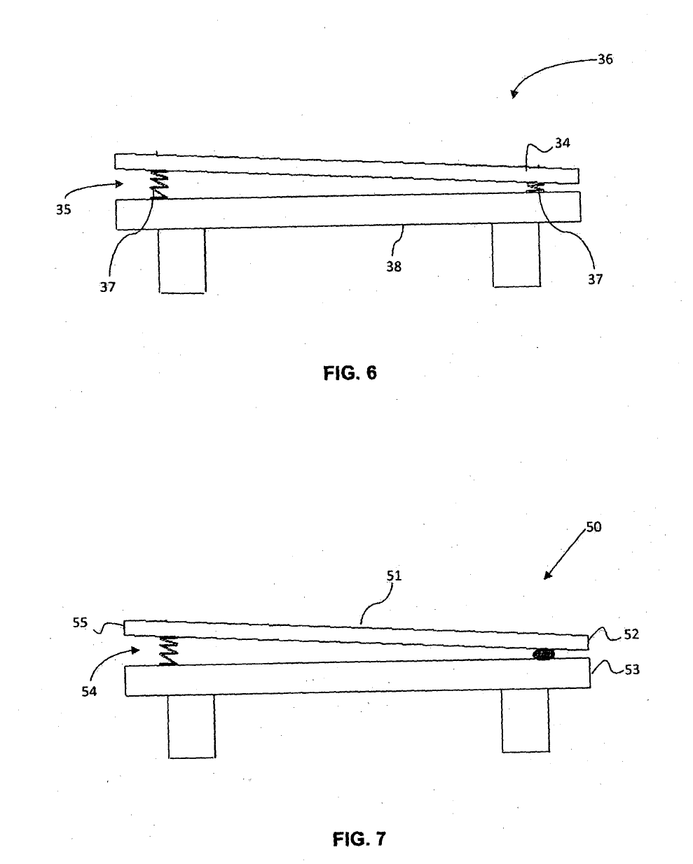

FIG. 6 shows the support 34 and the biasing mechanism 35 includes two biasing members 37, each disposed at one of two opposing ends of the support 34. The two biasing members 37 are disposed between the support 34 and a base 38 such as a fixture. The biasing members 37 may include spring elements or rubber pads or any resilient member capable of applying pressure on the bond area through the first substrate during the incremental increase of the bond area between the first substrate and the second substrate.

It will be appreciated that the support 34 may have a flatness of 20 microns (μm) or less so as to maintain a substantially planar surface during the incremental increase of the bond area between the first substrate 31 and second substrate 32. Optionally, the bonding device 30 may include a guide member located on the support 34 (not shown) and movable towards a central longitudinal axis of the support 34 to align the first substrate with the second substrate prior to applying pressure.

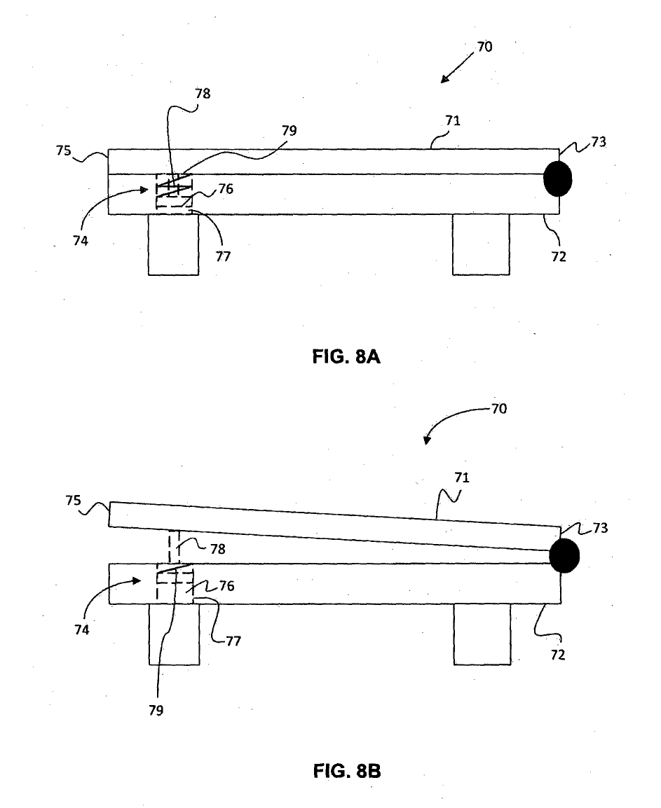

It will be appreciated that the support may have a tilted configuration as shown in FIG. 6 and FIG. 7 or a tiltable configuration as shown in FIG. 8A and FIG. 8B.

FIG. 7 shows a second configuration of a support 51 in a tilted configuration according to an aspect of the present invention. The 51 may have a first end 52 arranged to pivot about a base 53. A biasing mechanism 54 is disposed between the base 53 and a second end 55 of the support 51 located opposite to the first end 52 of the support 51. The biasing mechanism 54 may include a spring element, or a resilient member.

FIG. 8A shows a third configuration of a support 71 in a tiltable configuration prior to tilting according to an aspect of the present invention. FIG. 8B shows the support 71 in a tilted position. The support 71 may be arranged to pivot about a base 72 at a first end 73 of the support 71. There is a biasing mechanism 74 disposed between the base 72 and a second end 75 of the support 71 located opposite the first end 73 of the support 71. The biasing mechanism 74 may include a biasing member 76 such as for example, an actuator. The actuator may be a spring based piston assembly 76 having a piston or cylinder 77 and a piston rod 78 reciprocating in the cylinder 77 to raise the support 71 to a tilted position relative to the base 72 as shown in FIG. 8B and to lower the support 71 to lie alongside the base 72. A spring member 79 or a biasing member is provided in the spring based piston assembly 76 so as to provide a biasing force on the bond area through the first substrate during the incremental increase of the bond area between the first substrate and the second substrate.

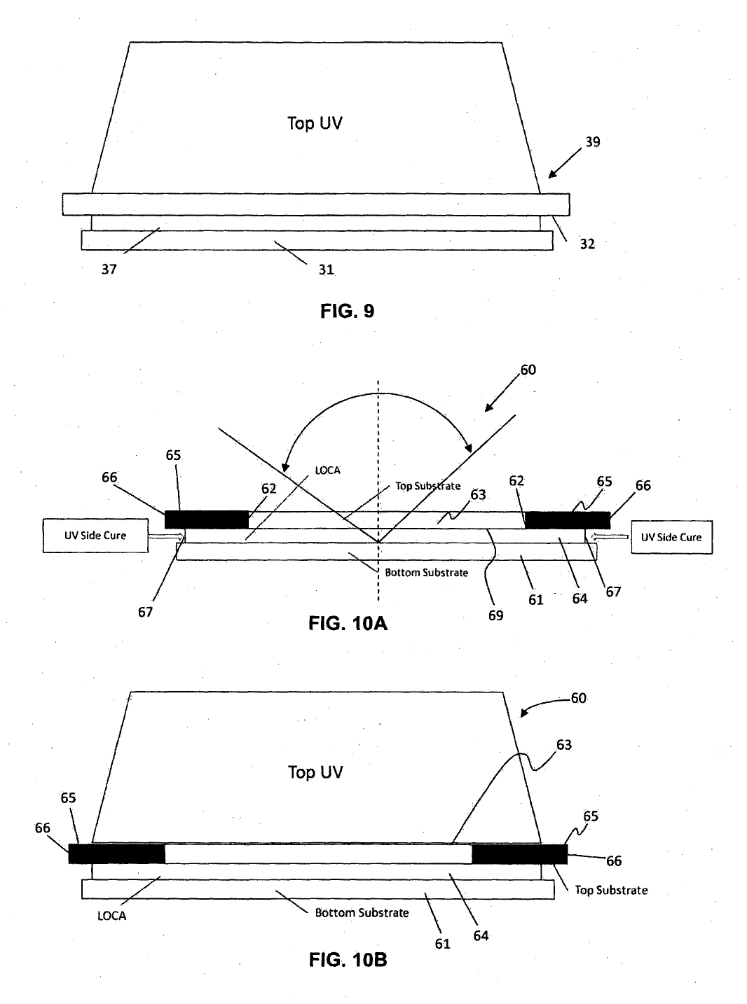

After the second substrate 32 is bonded to the first substrate 31 with the liquid adhesive 37 printed thereon to form a substrate assembly 39, it is required to cure the liquid adhesive 37 to form the laminated product. FIG. 9 is a cross-sectional view of the substrate assembly 39 during a full curing step. In FIG. 9, the second substrate 32 is a glass substrate with no coloured masking and the first substrate 31 is a LCD module, a full UV cure may be performed on the substrate assembly 39 to completely cure the liquid adhesive 37 to bond the first and second substrates to form the laminated product.

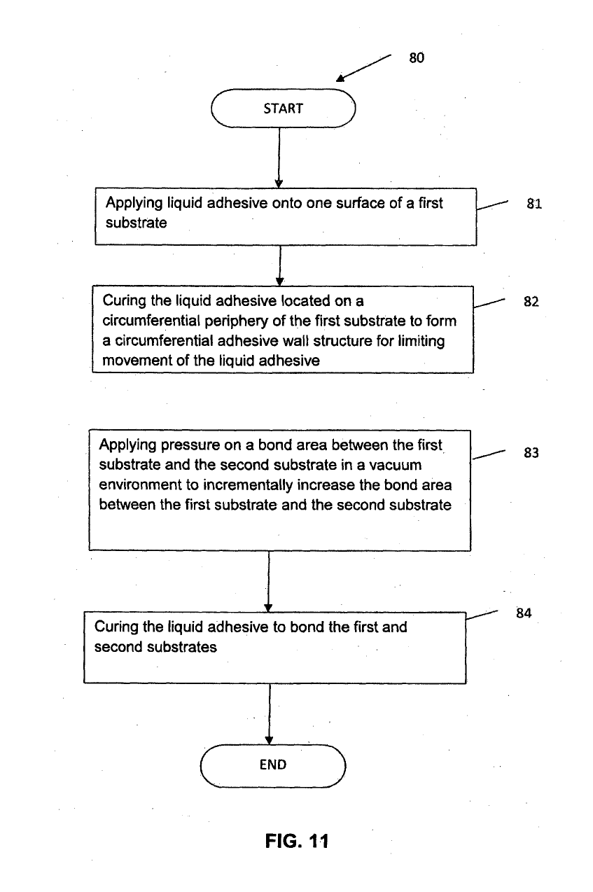

Optionally, in display applications such as a touch screen mobile device whereby the laminated product is a touch screen display and one of the two substrates in the laminated product is a cover glass with a coloured periphery, a two step curing process may be implemented to cure the liquid adhesive in the lamination process. FIG. 10A is a cross-sectional view of a substrate assembly 60 having a LCD module 61 with a liquid adhesive layer 64 printed on a surface of the LCD module 61, and a glass substrate 63 having a surface 69 for bonding to the LCD module 61. The surface 69 of the glass substrate may include a coloured masking 65 extending from an outer circumferential periphery 66 of the glass substrate 63 to an outer circumferential periphery 62 of the viewing area of the LCD module 61. The coloured masking may be a decorative ink mask including a black ink layer or a white ink layer extending about 1 millimeter (mm) from the outer circumferential periphery 66 to the outer circumferential periphery 62 into the viewing area of the LCD module 61.

The liquid adhesive 64 on the outer circumferential periphery 62 of the LCD module 61 and under the coloured masking of the glass substrate 63 may be cured by an edge cure by introducing a UV light directly at an adhesive edge 67 as shown in FIG. 10A.

FIG. 10B is a cross-sectional view of the substrate assembly 60 with a full UV cure performed on the substrate assembly 60 to completely cure the liquid adhesive to form the laminated product. The curing of the liquid adhesive by UV cure may be performed at room temperature or a temperature determined by the properties of the first and second substrates to minimise substrate warpage caused by differences in the coefficient of thermal expansion between the first and second substrates 61, 63. The UV light source may include a UV LED spot light source, or a UV lamp source. The advantage of using UV LED source for curing is that UV-LED source is solid state and has a long working lifespan.

FIG. 11 is a flow chart of a method 80 for forming a laminated product for a display device having a first substrate and a second substrate. In step 81, liquid adhesive may be applied on a surface of the first substrate for bonding the first substrate to the second substrate. In step 82, the liquid adhesive located on a circumferential periphery of the first substrate may be cured to form a circumferential adhesive wall structure for limiting movement of the liquid adhesive. In step 83, pressure may be applied on a bond area between the first substrate and the second substrate in a vacuum to incrementally increase the bond area between the first substrate and the second substrate to incrementally bond the first substrate to the second substrate. The pressure may be applied in a vacuum environment at a fixed setting or a variable setting, i.e. incrementally increasing the pressure applied according to the incremental increase in the bond area between the first substrate and the second substrate. In step 84, the liquid adhesive between the first and second substrates is cured to form the laminated product.

Step 83 may include tilting the first substrate to lie in a plane inclined relative to the second substrate prior to incrementally increasing the bond area between the second substrate and the first substrate.

Optionally, after step 83 and prior to step 84, a pressure in the vacuum chamber may be set at atmospheric pressure to compress all vacuum voids created during the lamination process. Air may be introduced into the vacuum chamber to enable the chamber pressure to reach atmospheric pressure quickly. A compressive force may be applied when the two substrates are in a compressed position to eliminate voids that may be present after the substrates are bonded at step 82. Dependent on the process requirements of the adhesive used in the lamination process and the substrates to be laminated, the compressive force may be varied accordingly. For example, where one of the substrates is a LCD display, the compressive force may be in the range of 1 to 4.5 kg/cm².

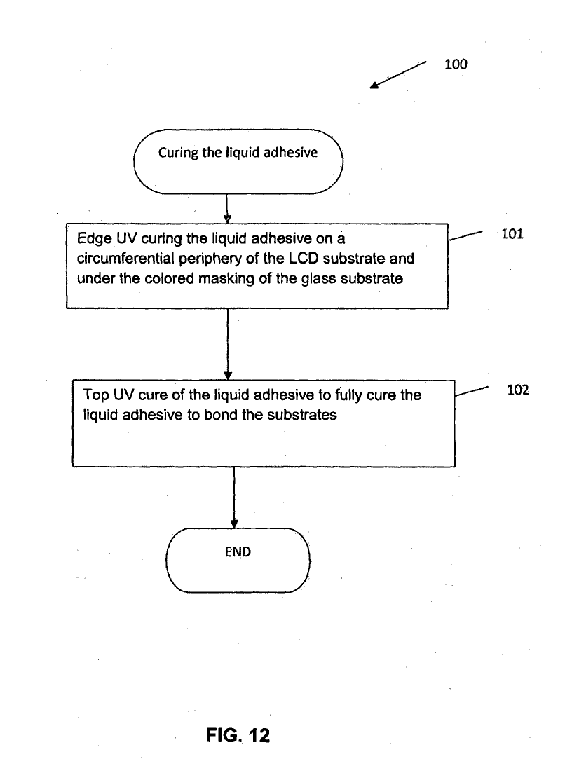

FIG. 12 is a flow chart of a method 100 for curing the liquid adhesive to form the laminated product. For example, in touch screen applications such as a touch screen mobile device whereby one of the two substrates in the laminated product is a cover glass with a coloured periphery as shown in FIG. 10A, a two step curing process may be implemented to cure the liquid adhesive in the lamination process after applying pressure in steps 83. In step 101, an edge UV cure may be applied to liquid adhesive on a circumferential periphery of the LCD substrate and under the colored periphery or masking of the glass substrate, followed by a top UV cure of the liquid adhesive in step 102 to fully cure the liquid adhesive to bond the glass substrate and the LCD substrate so as to form the laminated product.

Optionally, an alignment process can be introduced by providing a side guide on the biasing structure to align the first substrate prior to lamination or to align the first and second substrates prior to curing.

An inspection step may also be introduced to inspect for defects prior to subjecting the substrate assembly to a complete UV cure as shown in FIG. 10B. Defects may include dirt particles, parts stretches, misalignment between the substrates, air voids or the like. At the inspection step, the substrate assembly with the uncured adhesive may be disassembled, cleaned or reused or reworked. The advantage of reworkability of the substrate assembly prior to forming the laminated product is important to minimize material costs due to defective parts because the substrates such as LCD modules are very costly. Further, it is more environmentally friendly to be able to reuse and rework glass substrates because high amounts of energy is required in the production of glass substrates.

In an embodiment, uneven application of liquid adhesive on the substrate may be wiped using a wiper, prior to forming the circumferential adhesive wall structure for limiting movement of the liquid adhesive. The wiper may be coupled to a stencil printing device for printing the liquid adhesive and arranged such that as the liquid adhesive is printed on a substrate, the wiper simultaneously wipes any uneven application of liquid adhesive. The advantage of wiping the liquid adhesive is to maintain uniform thickness of the liquid adhesive in the aperture and to control planarity of the liquid adhesive printed on the substrate.

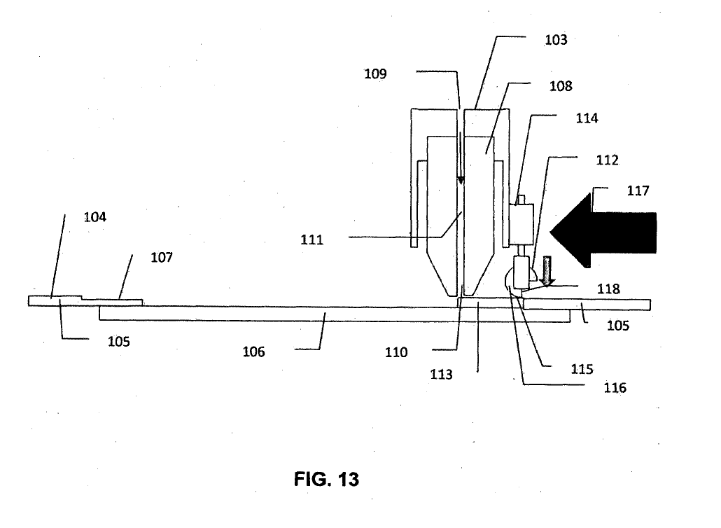

FIG. 13 is a side view of a stencil printing device 103 during a liquid adhesive printing step using a stencil 104. The stencil 104 is provided on a first substrate 106 and is similar in design to the stencil 10 as shown in FIG. 2A. Specifically, the stencil 104 has a stencil portion 105 with an aperture (not shown in the side view but similar to the aperture 13 of the stencil 10 of FIG. 2A) of size corresponding to a part of the surface of the first substrate 106. For example, the aperture may be of size corresponding to an intended print area on the surface of the first substrate 106. The stencil 104 further includes a recess 107 similar to the recess 14 of the stencil 10 of FIG. 2A whereby the recess 107 may be adapted to allow excess flow of liquid adhesive from the aperture.

During a liquid adhesive printing step, liquid adhesive 113 is dispensed from a dispenser 108 such as for example a slot die 108 to be printed on the first substrate 106. The slot die 108 has an inlet 109 for receiving liquid adhesive, an outlet 110 for dispensing liquid adhesive and a passageway 111 in communication with the inlet 108 and the outlet 110. The passageway 111 may be configured to allow liquid adhesive to be dispensed from the outlet 110. It will be appreciated that the slot die 108 is positioned such that the slot die 108 does not contact the liquid adhesive printed on the first substrate 106 and that there is a gap between a bottom surface of the slot die 108 and a top surface of the printed liquid adhesive. The stencil printing device 103 is configured to be movable across the aperture so as to print liquid adhesive dispensed from the slot die 108.

A wiper 112 may be coupled to the stencil printing device 103 at a rear end 113 of the stencil printing device 103 for wiping uneven application of liquid adhesive 113 printed on the first substrate 106. The wiper 112 may be configured to apply a controlled pressure to wipe any uneven application of liquid adhesive. The wiper 112 may be adjustable along its length to control the liquid adhesive thickness across the whole aperture of the stencil. The wiper 112 may be configured to be movable relative to the stencil printing device 103 in a substantially vertical direction for applying pressure on the stencil 104 to contact the stencil 104 before wiping. An actuator 114 may be coupled to the wiper 112 to enable the wiper 112 to be lowered towards or raised away from the stencil 104 along the vertical direction. Still further, the wiper 112 may be moved across the stencil 104 via movement of the stencil printing device 103 and has a curved profile 115 adapted for wiping liquid adhesive and to maintain uniform thickness of the liquid adhesive 113 on the first substrate 106. For example, the thickness of the liquid adhesive 113 may be controlled within 10% of an adhesive thickness profile defined by the requirements of an end product in which the laminated product is used. The wiper 112 may be an elongate rod member 116 having a curved profile 115 for line contact with the liquid adhesive 113 on the first substrate 106.

As the liquid adhesive 113 is dispensed and printed on the first substrate 106 by movement of the stencil printing device 103 in a first direction 117, the wiper 112 simultaneously wipes any uneven application of the liquid adhesive 113 printed on the first substrate 106 to control planarity of the liquid adhesive 113 and to maintain a consistent volume of the liquid adhesive 113. Although the wiping may be done after printing of the liquid adhesive 113 on the first substrate 106 is complete, wiping the uneven application of the liquid adhesive 113 simultaneously with printing of the liquid adhesive 113 enables reduction in production cycle time required in transfer of substrates with printed adhesive to a separate process module or station to perform wiping. In high volume production, such reduction in production cycle time lead to significant savings in time costs.

After the printing of the liquid adhesive 113 on the first substrate 106 is complete, any excess liquid adhesive wiped by the wiper 112 may be moved through movement of the stencil printing device 103 to the recess 107 of the stencil 104. The wiper 112 may further include a guide surface 118 for moving the excess liquid adhesive onto a next substrate to be used for forming a laminated product.

FIG. 14A is a top view of a stencil printing device 120 during a liquid adhesive printing step using a stencil 121 with a first recess 122, a second recess 123, and a aperture 124 extending from the first recess 122 to the second recess 123. The aperture 124 is similar to the aperture 13 of FIG. 2A and will not be discussed in further detail. The first and second recesses 122, 123 are configured for accommodating excess flow of liquid adhesive during a liquid adhesive printing step as the stencil printing device 120 is moved across the aperture 124 in a first direction 125.

FIG. 14B is a side view of the stencil printing device 120 during the liquid adhesive printing step where the stencil 121 is provided on a first substrate 126. Similar to the stencil printing device 103 of FIG. 13, the stencil printing device 120 has a slot die 127 for dispensing liquid adhesive and the stencil printing device 120 is configured to be movable across the aperture 124 so as to print liquid adhesive dispensed from the slot die 127.

A wiper 128 comprising a first wiper member 129 and a second wiper member 130 may be arranged on the stencil printing device 120 for wiping uneven application of liquid adhesive 131 printed on the first substrate 126. Specifically, the first wiper member 129 is attached to a rear end 131 of the stencil printing device 120 and the second wiper member 130 is attached to a front end 132 of the stencil printing device 120. Each of the first and second wiper members 129, 130 may be adjustable along its length to control the liquid adhesive thickness across the whole aperture of the stencil 121. Still further, the wiper 128 may be moved across the stencil 121 via movement of the stencil printing device 120.

The wiper 128 may be configured to be movable relative to the stencil printing device 120 in a substantially vertical direction for applying pressure on the stencil 104 to contact the stencil 121 before wiping. In particular, an actuator 114 may be coupled each of the first and second wiper member 129, 130 to enable the wiper members 129, 130 to be lowered towards for wiping or raised away from the stencil 104. For example, each of the wiper members 129, 130 may include an elongate rod member having a curved profile 132, 133 adapted for wiping liquid adhesive and to maintain uniform thickness of the liquid adhesive 131 on the first substrate 106. For example, the thickness of the liquid adhesive 131 may be controlled within 10% of an adhesive thickness profile defined by the requirements of an end product in which the laminated product is used.

In a liquid adhesive printing step as shown in FIG. 14B, the first wiper member 129 is lowered towards the stencil 121 for applying pressure on the stencil 121 while the second wiper member 130 is in an upward position away from the stencil 121. As the liquid adhesive 131 is dispensed and printed on the first substrate 126 by movement of the stencil printing device 120 in the first direction 125, the first wiper member 129 simultaneously wipes any uneven application of the liquid adhesive 131 printed on the first substrate 126 to control planarity of the liquid adhesive 131 and to maintain a consistent volume of the liquid adhesive 131. FIG. 14C is a side view of the stencil printing device 120 at the end of the liquid adhesive printing step where the liquid adhesive 131 is printed on the first substrate 126.

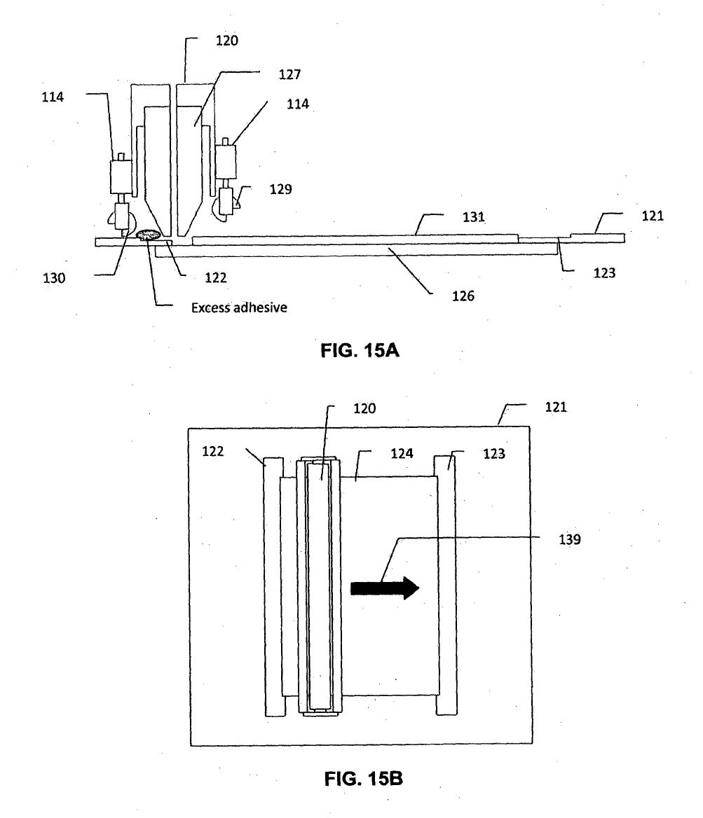

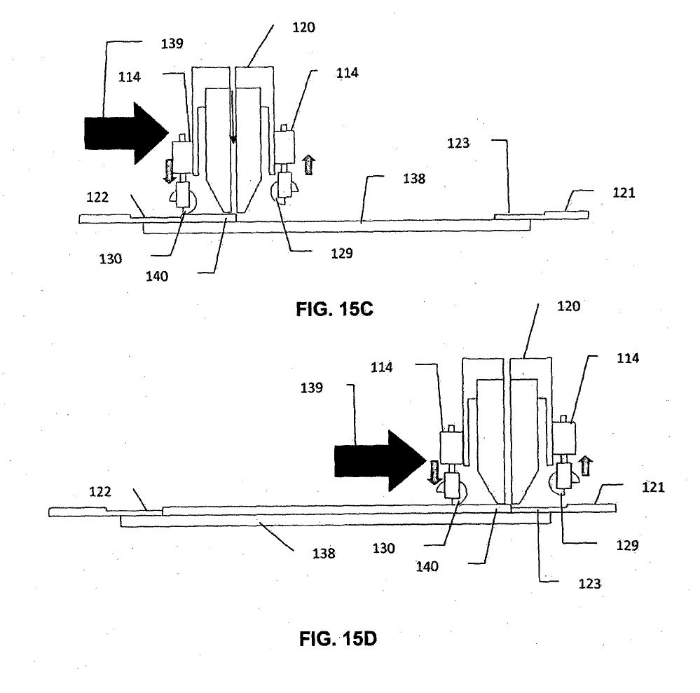

After the printing of the liquid adhesive 131 on the first substrate 126 is complete, any excess liquid adhesive wiped by the first wiper member 129 may be moved to the first recess 122 of the stencil 121 as shown in FIG. 15A. Each of the wiper members 129, 130 may further include a guide surface 137 for moving the excess liquid adhesive onto a next substrate to be used for forming a laminated product as shown in FIG. 15B to FIG. 15D. The first wiper member 129 may be retracted away from the stencil 121 and the second wiper member 130 may be extended or lowered to apply pressure on the stencil 121.

After removing the first substrate 126 with the liquid adhesive 131 printed thereon, the stencil printing device 120 is at a position of the end of a liquid adhesive printing step, i.e. adjacent or at the first recess 122 of the stencil 121. As shown in FIG. 15C, another first substrate 138 may be loaded and the stencil 121 is provided on the first substrate 138 to start another liquid adhesive printing step for forming a laminated product having the first substrate 138 and a second substrate.

FIG. 15B is a top view of the stencil printing device 120 during a liquid adhesive printing step whereby the stencil printing device 120 is at the position of the end of an earlier liquid adhesive printing step and is movable in a second direction 139 opposite the first direction 125 for printing liquid adhesive on the first substrate 138. Referring to FIG. 15C, the second wiper member 130 is extended or lowered towards the stencil 121 for applying pressure on the stencil 121 while the first wiper member 129 is retracted in an upward position away from the stencil 121. Any excess liquid adhesive from the earlier liquid adhesive printing step is being moved by the second wiper member 130 to be deposited with liquid adhesive 140 dispensed from the slot die 127 for printing on the first substrate 138. Similar to FIG. 14B, as the stencil printing device 120 moves in the second direction 139 for printing the liquid adhesive on the first substrate 138, the second wiper member 130 simultaneously wipes any uneven application of the liquid adhesive 140 printed on the first substrate 138 to control planarity of the liquid adhesive 140 and to maintain a consistent volume of the liquid adhesive 140. FIG. 15D is a side view of the stencil printing device 120 at the end of the liquid adhesive printing step of FIG. 15B where the liquid adhesive 140 is printed on the first substrate 138.

After the printing of the liquid adhesive 140 on the first substrate 138 is complete, any excess liquid adhesive wiped by the second wiper member 130 may be moved to the second recess 123 of the stencil 121 in a similar manner as shown in FIG. 15A for reuse in a next liquid adhesive printing step. Reuse of any excess liquid adhesive minimizes the wastage of liquid adhesive which results in material costs savings. More importantly, the volume of liquid adhesive to be applied on a substrate for forming a laminated substrate assembly may be controlled and hence the volume of the liquid adhesive may be consistent.

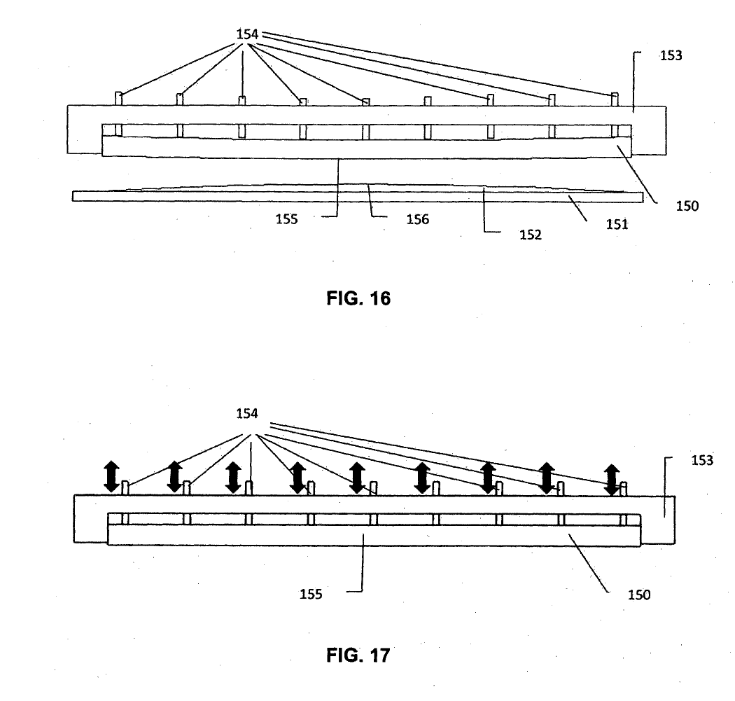

FIG. 16 is a front view of a wiper 150 with a first substrate 151 with liquid adhesive 152 printed on the first substrate 151. During a liquid adhesive printing step, the surface 156 of the liquid adhesive 152 printed on the first substrate 151 may not be planar and hence the liquid adhesive 152 may not have a uniform thickness. As shown in FIG. 16, the liquid adhesive 152 has a non-uniform thickness across an intended print area of the surface of the first substrate 151. As shown in FIG. 16 and FIG. 17, to maintain planarity of the liquid adhesive during wiping, the wiper 150 may include a holder 153 having a plurality of adjustable supports 154 adapted for adjusting a height profile of the wiper 150 with respect to the surface of the liquid adhesive across the length of the wiper 150. The adjustable supports 154 may be fasteners which are adjustable within the holder to obtain a desired height profile of the wiper 150 according to the profile of the surface of liquid adhesive printed on a substrate. For example, in FIG. 17 where the liquid adhesive 152 is printed thicker at the center of the intended adhesive print area, the height profile of the wiper 150 may be adjusted by increasing a height in a center portion of the wiper 150 to form a curved profile 155 so as to remove more adhesive at the centre during wiping.

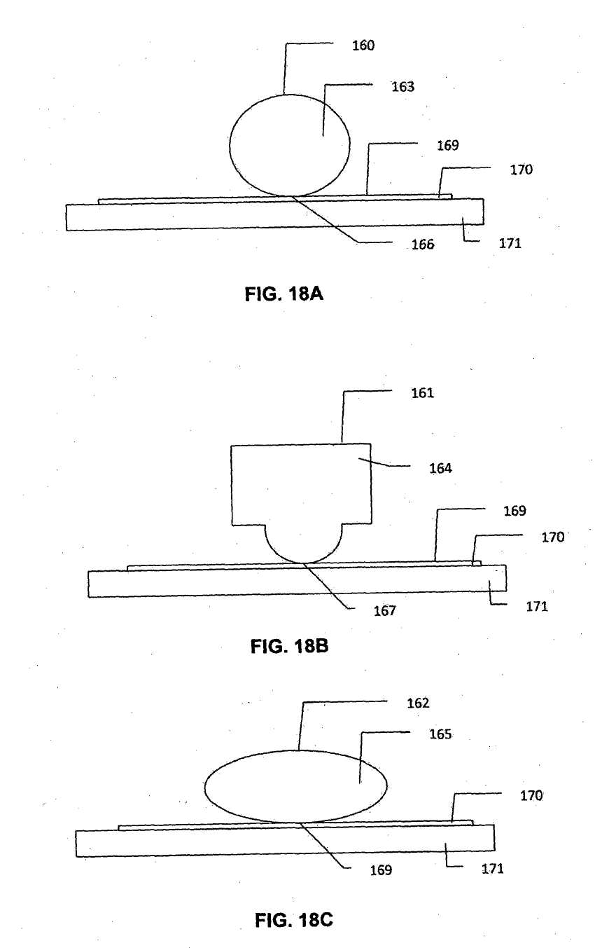

Wipers with circular cross section areas having a quadrant shaped slot have been used as examples in the description for the wipers in FIG. 13, FIG. 14A to 14C, FIG. 15A to 15D. However, it will be appreciated that wipers with other cross section areas of other shapes may be used as long as the wipers have a curved profile to obtain a line contact with the liquid adhesive during wiping of the liquid adhesive on the substrate to control the printed adhesive planarity within 10% of a adhesive weight and adhesive thickness profile defined by the requirements of an end product in which the laminated product is used. FIGS. 18A, 18B and 18C illustrate enlarged cross sectional views showing examples of different wipers 160, 161, 162 with different cross sectional areas 163, 164, 165 respective. Each of the cross sectional areas 163, 164, 165 has a curved profile 166, 167, 168 respective to obtain a line contact with a surface 169 of the liquid adhesive 170 printed on a substrate 171 to control planarity of the printed adhesive 170 during wiping.

The present invention may be used for lamination of two or more substrates to form a laminated product in various applications which use laminated products such as for example, displays. The laminated product may include a touch screen assembly, a display panel, a composite laminate, or a layered product having at least two layers bonded together with an adhesive layer. An advantage of using the biasing structure in the lamination process is to obtain a good sealing effect in the laminated product. Consequently, good dimensional accuracy, optical clear appearance, good holding strength as well as good capacitive or resistive response can be achieved in laminated products such as displays with touch sensitive properties.

Although rigid materials have been used as examples in the above description for the substrates in the lamination process, it will be appreciated that a flexible substrate having a thickness and rigidity suitable to form a planar surface for stencil printing of the liquid adhesive, may also be a substrate. For example, the flexible substrate may be made of a material include but not limited to polyester, polyimide, or printable polymer material having mechanical and thermal properties suitable for forming laminated products. The first substrate and the second substrate may include more than one layer. It will be appreciated that the adhesive used in the lamination process should not be volatile if used in a vacuum environment.

For ease of description, UV curable adhesives and UV curing of the liquid adhesives have been described herein, but it is to be understood that other types of printable liquid adhesives or other curing methods such as visible light curing may be used in the process for forming the laminated product.

The printable adhesives used in forming laminated products may include adhesives that are thixotropic or non-thixotropic provided that the adhesive material is able to flow freely into the aperture of the stencil and then recover quickly to resist slump after printing. The printable adhesives may include adhesives having a viscosity in the range of 15,000 centipoise (cps) to 100,000 cps at a shear rate of 1 sec⁻¹ or adhesives having a lower viscosity. The liquid adhesive should also have good wetting properties in that it should not flow after printing within a specified processing time, such as for example, 20 seconds.

For manufacturing of laminated products for use in displays, the liquid adhesive may be a liquid optically clear adhesive with properties suitable for bonding display substrates such as glass, plastics, LCD, touch screen substrate or the like. The liquid adhesive may include a UV curable adhesive.

Still further, liquid adhesives of different viscosities may be used for printing on the first substrate. Table 1 lists examples of liquid adhesives that may be used in forming a laminated product such as for example, a touch screen LCD display device. The liquid adhesives Examples 1 to 3 have a range of viscosity measurements measured over a shear rate range of 0.001 to 100 sec⁻¹ at 25 degrees Celsius (° C.).

### EXAMPLES

TABLE 1

| Shear Rate (1/sec) | | 0.01 | 0.1 | 1 | 10 | 100 |
|---|---|---|---|---|---|---|
| Example 1 | Viscosity (Pa-s) | 1843 | 459 | 98.6 | 36.2 | 21 |
| Example 2 | | 702 | 183 | 40 | 16 | 10 |
| Example 3 | | 4.5 | 4 | 3.5 | 3.55 | 3.6 |

### Example 1

Example 1 is a thixotropic liquid optically clear adhesive having a viscosity over a shear rate range of 0.001 to 100 sec⁻¹ as listed in Table 1. Example 1 may be printed on a first substrate such as a LCD display panel using a stencil as. The aperture may be of a size: 481.7 millimeters (mm) by 273.8 millimeters (mm) which may be bigger than a viewing area of the LCD panel by 5 millimeters (mm). The adhesive thickness may be about 300 microns (μm), with a tolerance of +1-15 microns (μm). Prior to applying pressure to bond a cover glass to the LCD panel with printed liquid adhesive, the printed adhesive may be partially circumferentially cured to limit movement of the liquid adhesive by UV light curing based on 15% dosage of a full UV curing of the liquid adhesive. The circumferential width of the partially cured adhesive may be 2 millimeters (mm).

The display panel with the liquid adhesive printed thereon and a cover glass may be bonded or laminated by applying a pressure in a vacuum environment set at a pressure of 100 pascal or process conditions as described in FIGS. 5A and 5B. Subsequently, a pressure of 2 kg/cm² may be applied on the cover glass and display panel under atmospheric conditions or atmospheric pressure to eliminate any voids remaining after lamination, followed by a complete UV cure based on process conditions as described and shown in FIG. 10B. The complete UV cure is to bond the substrates to form a laminated LCD panel. After curing, the laminated LCD panel does not show presence of defects such as for example, yellow band, mura, void. An advantage of the present invention is that the overflow of liquid adhesive may be controlled.

### Example 2

Example 2 is a thixotropic liquid optically clear adhesive having a range of viscosity measurements lower than the viscosity measurements that of Example 1. Example 2 may be used to form a laminated product and the process conditions may be similar to as the process conditions for forming the laminated product using the liquid adhesive of Example 1.

### Example 3

In Example 3, a non-thixotropic liquid optically clear adhesive having a lower viscosity than that used in Example 2 may be used. The process conditions in forming a laminated product using Example 3 may be similar to as the process conditions for forming the laminated product using the liquid adhesive of Example 1. The above viscosity measurements may be determined over a shear rate range of 0.001 to 100 sec⁻¹ at 25 degrees Celsius (° C.) using a rheometer such as for example a AR2000 Rheometer (manufactured by TA Instruments) equipped with a 40 millimeters (mm) diameter by 1° cone. Advantageously, after curing, the laminated LCD panels or products formed using the liquid adhesives in Examples 1, 2, and 3 do not show presence of defects such as for example, yellow band, mura, void. A further advantage of the present invention is that the overflow of liquid adhesive may be controlled.

A description has heretofore been given of the invention, using the embodiments, but the configuration described so far in each embodiment being only one example, the invention can be appropriately modified without departing from the scope of the technological idea. Also, it is also acceptable that the configurations described in the individual embodiments are used in combination unless they conflict with each other.

1. A method for forming a laminated product having a first substrate and a second substrate, the method comprising the steps of:
a) applying a liquid adhesive on a surface of the first substrate for bonding the first substrate to the second substrate;
b) curing the liquid adhesive located on a circumferential periphery of the first substrate so as to form a circumferential adhesive wall structure for limiting movement of the liquid adhesive within the circumferential adhesive wall structure;
c) applying pressure on a bond area between the first substrate and the second substrate in a vacuum environment to incrementally increase the bond area between the first substrate and the second substrate to incrementally bond the first substrate to the second substrate; and
d) curing the liquid adhesive to bond the first and second substrates.

2. The method as claimed in claim 1, wherein the step (b) includes:
tilting the first substrate to lie in a plane inclined relative to the second substrate prior to incrementally increasing the bond area between the second substrate and the first substrate.

3. The method as claimed in claim 2, wherein tilting the first substrate includes:
providing the first substrate on a support configured for holding the first substrate; and
biasing the support between a first position using a biasing mechanism coupled to the support wherein the support is in alignment with the inclined plane and a second position wherein the support is biased to apply pressure on the bond area through the first substrate during the incremental increase of the bond area between the first substrate and the second substrate.

4. The method as claimed in claim 3, wherein one end of the support is arranged to pivot about a base and the biasing mechanism is disposed between the base and the support.

5. The method as claimed in claim 4, wherein the biasing mechanism includes a biasing member.

6. The method as claimed in claim 5, wherein the biasing member includes one of: a spring element, a rubber pad, an actuator.

7. The method as claimed in claim 6, wherein the actuator is a spring based piston assembly.

8. The method as claimed in claim 3, wherein the biasing mechanism includes two biasing members, each disposed at one of two opposing ends of the support, the two biasing members being disposed between the support and a base.

9. The method as claimed in claim 1, wherein curing the liquid adhesive located on the circumferential periphery of the first substrate includes partially curing liquid adhesive located on a circumferential periphery of an adhesive print area on the first substrate.

10. The method as claimed in claim 9, wherein partial curing the liquid adhesive includes:
providing a mask on the first substrate, the mask having an aperture for exposing the liquid adhesive on the circumferential periphery of the adhesive print area to a curing source; and
partial curing the liquid adhesive on the circumferential periphery of the adhesive print area to form the circumferential adhesive wall structure using the curing source.

11. The method as claimed in claim 9, wherein the curing source is a spot Light Emitting Diode (LED) light source.

12. The method as claimed in claim 1, wherein step (a) includes:
providing a stencil on the surface of the first substrate, the stencil having a stencil portion with an aperture of size corresponding to the surface of the first substrate for receiving the liquid adhesive; and
stencil printing the liquid adhesive on the surface of the first substrate.

13. The method as claimed in claim 1, further comprising wiping uneven application of liquid adhesive on the first substrate prior to the step (b) to maintain uniform thickness of the liquid adhesive on the first substrate.

14. The method as claimed in claim 12, wherein the stencil portion includes a tapered portion to accommodate excess flow of liquid adhesive.

15. The method as claimed in claim 12, wherein the stencil portion includes a recess adapted to accommodate excess flow of liquid adhesive.

16. The method as claimed in claim 15, wherein the recess having a depth of less than the thickness of the stencil portion and an area extending along an edge of the stencil portion adjacent to the aperture.

17. The method as claimed in claim 1, wherein the first substrate and the second substrate are made of a rigid material.

18. The method as claimed in claim 1, wherein the first substrate or the second substrate is made of a flexible material.

19. The method as claimed in claim 1, wherein the first substrate is a LCD module having a viewing area, and the second substrate is a glass substrate having a bottom surface for bonding with the viewing area.

20. The method as claimed in claim 19, wherein the bottom surface of the glass substrate includes a coloured masking extending from an outer circumferential periphery of the glass substrate to an outer circumferential periphery of the viewing area.

21. The method as claimed in claim 20, wherein curing the liquid adhesive includes curing the liquid adhesive on a circumferential periphery of the LCD substrate and under the coloured masking of the glass substrate.

22. The method as claimed in claim 1, wherein the liquid adhesive is a thixotropic liquid adhesive.

23. The method as claimed in claim 1, wherein the laminated product is a laminated substrate assembly for a display device.

24. A display device having a laminated product formed according to claim 1.

25. An apparatus for forming a laminated product having a first substrate and a second substrate, the apparatus comprising:
a stencil printing device for applying a liquid adhesive on a surface of the first substrate for bonding the first substrate to the second substrate;
a bonding device having:
a platen configured for holding a second substrate and for applying pressure on a bond area between the first substrate and the second substrate;
a support configured for holding a first substrate; and
a biasing mechanism configured to bias the support between a first position wherein the support lies in a plane inclined relative to the second substrate, and a second position wherein the support is biased to apply pressure on the bond area through the first substrate to incrementally increase the bond area on which the pressure is applied to incrementally bond the first substrate to the second substrate;
a curing device for curing the liquid adhesive, wherein the liquid adhesive located on a circumferential periphery of the first substrate is cured by the curing device in a manner such that a circumferential adhesive wall structure is formed for limiting movement of the liquid adhesive within the circumferential adhesive wall structure before pressure is applied on the bond area by the actuator.

26. The apparatus as claimed in claim 25, wherein the curing device is used with a mask to form the circumferential adhesive wall structure.

27. The apparatus as claimed in claim 25, wherein a first end of the support is arranged to pivot about a base and the biasing mechanism is disposed between the base and the support.

28. The apparatus as claimed in claim 25, wherein the biasing mechanism includes a biasing member.

29. The apparatus as claimed in claim 25, wherein the biasing mechanism includes two biasing members, each disposed at one of two opposing ends of the support, the two biasing elements being disposed between the support and a base.

30. A stencil for printing adhesive in a process for forming a laminated product having a first substrate and a second substrate, the stencil comprising:
a stencil portion with an aperture of size corresponding to a surface of the first substrate for receiving a liquid adhesive to be applied on the surface of the first substrate for bonding the first substrate to the second substrate.

31. The stencil as claimed in claim 30, wherein the stencil portion includes a tapered portion.

32. The stencil as claimed in claim 30, wherein the stencil portion includes a first recess adapted to allow excess flow of liquid adhesive from the aperture.

33. The stencil as claimed in claim 31, wherein the recess having a depth of less than the thickness of the stencil portion and an area extending along an edge of the stencil portion adjacent to the aperture.

34. The stencil as claimed in claim 31, further comprising a second recess adapted to allow excess flow of liquid adhesive from the aperture.

35. The stencil as claimed in claim 31, further comprising a second aperture in the stencil portion for accommodating placement of a component.
